(19) United States
(12) Patent Application Publication
(10) Pub. No.: US 2006/0028177 A1
(43) Pub. Date: Feb. 9, 2006

(54) Battery charger on cart

(76) Inventors: Theresa Ferro, Wenonah, NJ (US); Frank Perro III, Mantua, NJ (US)

Correspondence Address: THE INVENTORS NETWORK, INC., 332 ACADEMY STREET, CARNEGIE, PA, 15106, US

(21) Appl. No.: 10/914,060

(22) Filed: Aug. 9, 2004

(51) Int. Cl. H02J 7/00

(52) U.S. Cl. 320/114

(57) ABSTRACT

A portable cart-supported battery charger includes a tubular framework having a L-shaped lower portion that forms a cradle for elevating the housing that is supported thereon, and a u-shaped handle detachably securable to the L-shaped lower portion, and the L-shaped lower portion having a pair of wheels so that the battery charger is portable. A pair of handle knobs secures the handle to the L-shaped lower portion, and loosening the handle knobs allows for the removal of the handle from the L-shaped lower portion while tightening the handle knobs secures the handle to the L-shaped lower portion. One battery cable holder projects from the handle and one cable holder projects from the L-shaped lower portion for supporting the battery cables and clamps. The host battery and the AC charger are contained within the housing, and gauges on the front panel of the housing are easily viewable to the user because of the position of the housing on the framework of the battery charger.

### FIELD OF THE INVENTION

The present invention pertains to automotive equipment, and more particularly pertains to a cart-supported portable battery charger.

### BACKGROUND OF THE INVENTION

Automotive vehicles that remain idle for an extended time period encounter numerous problems, foremost among the problems being that the charge on the battery can be depleted to such an extent that the electrical system will not be powered and the vehicle will not start. In order to start the automotive vehicle, the individual—whether the individual is a private owner, a garage owner or mechanic, a tow truck operator or an attendant at a car lot—can connect a battery booster in parallel to the dead battery of the vehicle to boost or jump start the vehicle. The battery booster is disconnected after the vehicle is started, and the battery booster is returned to its storage location.

When the terrain is flat and unobstructed, pushing and positioning the battery booster adjacent the vehicle that needs the jumpstart is not excessively difficult. However, it is often the case that the vehicle requiring the battery boost is not parked in a parking lot, but is located in uneven, rough, rugged, hilly, muddy or sandy terrain. Maneuvering the battery booster into position on such terrain is not an easy task; and, in fact, can be quite physically demanding, even for an individual in good physical shape. Moreover, after each use, the battery booster should be plugged back into a 110-volt AC outlet for maintaining the charge in the host battery that comprises part of the battery booster. This is not always done, and thus the individual may find out too late, after struggling to position the battery booster over undesirable terrain, that the charge in the battery booster is inadequate to jumpstart the dead vehicle. The individual must then pull or push the battery booster to the nearest AC outlet to recharge the battery booster, so that the battery booster can then be repositioned to charge the dead battery of the immobile vehicle.

Thus, the prior art discloses a number of different types of battery boosters and chargers having various housings and supports. For example, the Corvette patent (U.S. Pat. No. 4,161,682) discloses a portable battery charger that includes a rectifier and battery enclosed within a housing that is supported on a L-shaped frame. The jumper cables are retractable within the housing.

The Manis et al. patent (U.S. Pat. No. 4,902,955) discloses a portable battery charger that includes a rectifier, a battery and an air compressor all enclosed within a housing with the clamps of the charging cables disposed on saddle notches on the housing when not in use.

The Collier patent (U.S. Pat. No. 5,039,930) discloses a battery booster that includes a battery and an AC charger enclosed within a housing, and a solar panel mounted on the housing roof for charging the battery when the AC charger is not powered.

The Brown patent (U.S. Pat. No. 5,574,622) discloses a mobile power distribution device that can provide up to 12,000 watts of power from a 220-volt source.

The Madura et al. patent (U.S. des. Pat. No. 425,018) and the Frank patent (U.S. des. Pat. No. 418,809) disclose designs for portable generators and AC power sources.

Nonetheless, despite the ingenuity of the above devices, there remains a need for a cart-supported battery charger that is designed for ease of movement over any kind of terrain for recharging dead batteries.

### SUMMARY OF THE INVENTION

The present invention comprehends a portable battery charger mounted on a cart that is easy to maneuver and position adjacent the vehicle that needs charging because of the configuration of the cart and the location of the housing on the cart. The portable cart for the battery charger includes a framework that comprises a u-shaped handle that is removably securable to an L-shaped lower portion by a pair of handle knobs that lock and unlock the handle to the L-shaped lower portion. The L-shaped lower portion forms a cradle for supporting the housing that encloses the host battery and the AC charger, and mounted on an external panel of the housing are the various gauges such as the power on/off switch and the amp meter. The housing includes a holder for the electrical cord that is plugged into a conventional 110-volt AC electrical outlet, and a battery cable holder projects from the handle and the L-shaped lower portion for supporting the battery cables and clamps when they are not being used.

It is an objective of the present invention to provide a cart-supported battery charger that allows the individual to easily and effortlessly push or pull the battery charger to the desired location while avoiding strain to the back, shoulders and arms.

It is another objective of the present invention to provide a cart-supported battery charger that is ergonomically designed so as to eliminate the need to bend over when moving the battery charger to the desired location and from one location to another location.

It is yet another objective of the present invention to provide a cart-supported battery charger that elevates the battery charger so that the gauges are easily viewable by the individual.

These and other objects, features and advantages will become apparent to those skilled in the art upon a perusal of the following detailed description read in conjunction with the following drawing figures.

### BRIEF DESCRIPTION OF THE DRAWINGS

FIG. 1 is a perspective view of the portable cart-supported battery charger of the present invention;

FIG. 2 is a perspective view of the cart-supported battery charger illustrating the portable framework that supports the housing enclosing the host battery and the charger;

FIG. 3 is a side elevational view of the portable cart-supported battery charger of the present invention illustrating the various gauges located on the side of the housing; and

FIG. 4 is a perspective view of the portable cart-supported battery charger of the present invention illustrating the handle knob and the lower portion of the detachable u-shaped handle.

### DETAILED DESCRIPTION OF THE PREFERRED EMBODIMENT

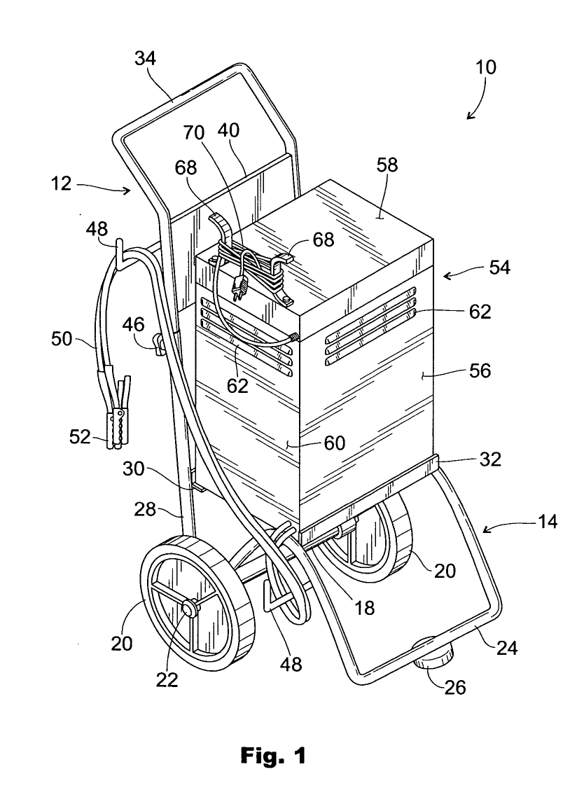

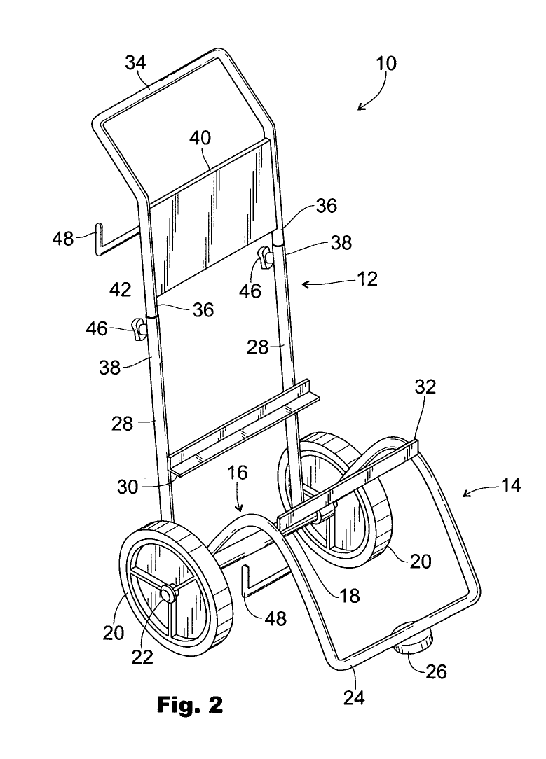

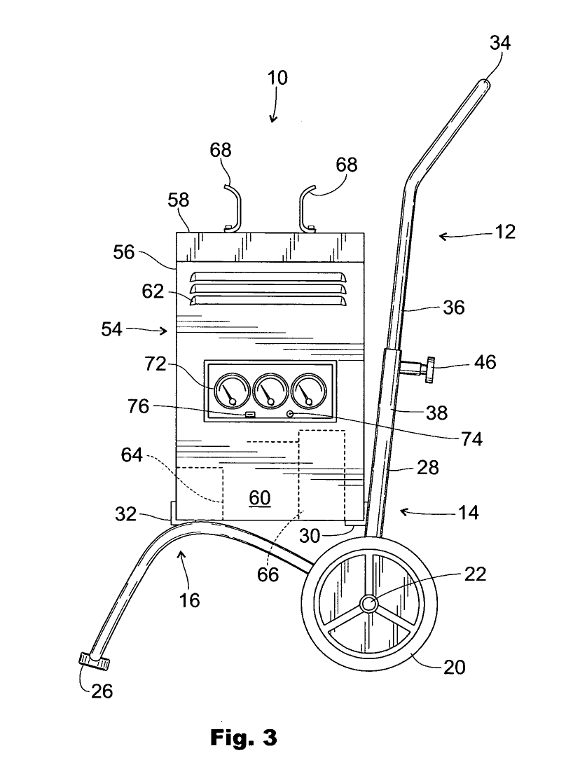

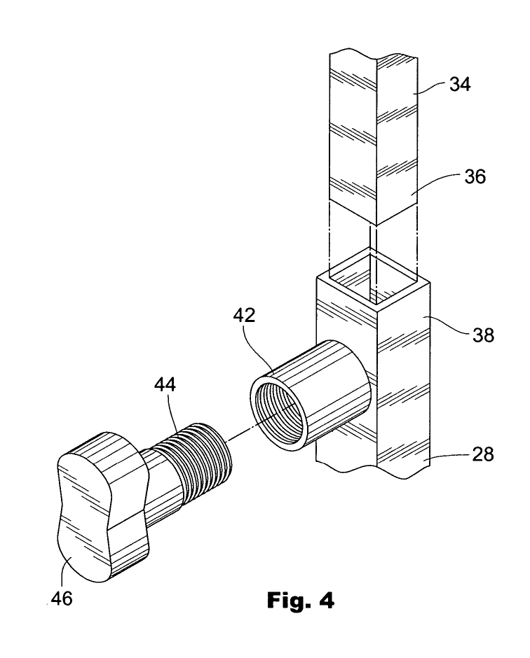

Illustrated in FIGS. 1-4 is a portable battery charger 10 supported on a cart that is easier to move and position on varying types of terrain for charging a dead battery because of certain design features that minimize the physical strain involved in pushing and pulling the battery charger 10, and that also make the battery charger 10 easier to use and operate.

As shown in FIGS. 1-4, the portable battery charger 10 of the present invention includes a framework 12 of steel tubing that is preferably one inch square iron tubing. The framework 12 is further comprised of an L-shaped lower portion 14, and the L-shaped lower portion 14 includes a cradle portion 16. The cradle portion 16 resembles an inverted v, and the L-shaped lower portion 14 can be one continuous piece of steel tubing that is interconnected at the rear by an axle 18. Mounted at each opposed end of the axle 18 is a rubber wheel 20, and the wheels 20 are secured to the axle 18 by press-on caps 22.

As illustrated in FIGS. 1-3, the front of the cradle portion 16 includes an integral crosspiece 24, and mounted to the crosspiece 24 is a footpad 26, preferably of rubber. The footpad 26 assists in stabilizing the battery charger 10 when the battery charger 10 is stationed adjacent to the vehicle that needs a battery charge. The L-shaped lower portion 14 also includes two upright members or stanchions 28 and a rear-housing bracket 30 extends between and is adjoined to both upright members 28. A front housing bracket 32 is mounted at the bight of the cradle portion 16, and at the same level as the rear-housing bracket 30 and extends transverse to the cradle portion 16.

Illustrated in FIGS. 1-4 is a u-shaped handle 34 that is detachably securable to the uprights 28 of the L-shaped lower portion 14. The handle 34 includes opposed handle ends 36, and each handle end 36 is receivable into the upper end 38 of each upright 28. From the axle 18 to the upper end of the uprights is approximately 30 inches, and the securement of the handle 34 adds more height to the battery charger 10 for reducing the physical strain involved in pushing and pulling the battery charger 10. In addition, a support plate 40 extends between and is attached to the handle 34. The support plate 40 provides a surface against which the individual can brace his or her knees and legs when moving the battery charger 10 for transporting and positioning. Projecting rearward and horizontally from the upper end 38 of each upright 28 is an internally threaded socket 42, and each socket 42 registers with the channel of each upright 28 so that a threaded shank 44 of a handle knob 46 can be inserted into the socket 42 for abutting the ends 36 of the handle 34. The handle 34 is secured to the uprights 28 of the L-shaped lower portion 14 by tightening the shanks 44 of the handle knobs 46 against the ends 36 of the handles 34 after they have been inserted into the upper ends 38 of the uprights 28; and the handle 34 is releasable from the L-shaped lower portion 14 by backing the shanks 44 of the handle knobs 46 out of the sockets 42. The detachable handle 34 thus allows the battery charger 10 to be broken down for transportation and storage purposes.

As shown in FIGS. 1-4, the battery charger 10 includes at least two battery cable holders 48 on which a pair of jumper battery cables 50 and clamps 52 (for carrying the positive and negative electric charge) can be placed thereon when the jumper battery cables 50 are not in use. Specifically, one battery cable holder 48 outwardly extends from the handle 34 and one battery cable holder 48 outwardly extends from the cradle portion 16 of the L-shaped lower portion 14.

The battery charger 10 includes a housing 54 that is supported on the framework 12, and, more specifically, the housing 54 is supported on and secured to the brackets 30 and 32. The housing 54 includes a front side 56, a topside 58, and opposed vertical sides 60, and vents 62 to allow for heat dissipation when the battery charger 10 is in operation. Enclosed within the housing 54 are a host battery 64 and an AC-powered charger 66 for providing the charge to the dead battery. A pair of electrical cord holder brackets 68 is mounted on the topside 58 of the housing 54 so that an electrical cord 70 can be wrapped thereon when the battery charger 10 is not in use. The electrical cord 70 is electrically connected to the charger 66 and can be plugged into a standard 110-volt AC outlet for providing the necessary electrical charge to maintain the charger 66. The battery charger 10 also includes a number of standard gauges and switches that are electrically interconnected to the battery 64 and the charger 66 for performing a number of functions that can include monitoring the current flowing from the host battery 64 to the dead battery, for visually indicating to the user that current is flowing from the host battery 64 to the dead battery during a battery jumpstart, turning the battery charger 10 on after the electrical cord 70 has been plugged into the 110-volt AC outlet for charging the unit, and turning the battery charger 10 off before unplugging the electrical cord 70 when the AC charger 66 has been sufficiently charged. Thus, the switches and gauges can include a meter 72 for monitoring current flow from the host battery 64 to the dead battery throughout the jumpstarting process, an indicator lamp 74 for visually indicating that current is flowing from the host battery 64 to the dead battery during the jumpstart, and an power on/off switch 76 for turning the battery charger 10 on and off.

In operation the individual would push or pull the battery charger 10 to a position adjacent the engine of the automotive vehicle that needs the battery jumpstart. The upwardly projecting handle 34 and the higher positioning of the housing 54 on the framework 12 reduces the strain and difficulty of maneuvering the battery charger 10 into position. The individual would then unwrap the battery cables 50 from the battery cable holders 48 and appropriately attach the positive and negative clamps 52 to the positive and negative terminals of the vehicle's dead battery. The individual would monitor the various gauges, including the ammeter gauge 72 and the indicator lamp 74, to verify that the drained battery was being charged, and that current was flowing from the host battery 64 to the drained battery. After charging of the dead battery is completed, the clamps 52 would be disconnected from the terminals of the now newly charged battery, the battery cables 50 would be wrapped around the battery cable holders 48, and the framework 12 would be slightly tilted to lift the footpad 26 off the ground so that the individual can easily wheel the battery charger 10 back to the storage site. It is recommended that the electrical cord 70 be immediately plugged back into the 110-AC electrical outlet to recharge the host battery 64 of the battery charger 10.

While a preferred embodiment has been shown and described, it will be understood by those skilled in the art that numerous modifications, alterations, and variations are possible and practicable and will still fall within the spirit and scope of the invention as defined by the appended claims.

We claim:

1. A portable battery charger for charging the battery in an automotive vehicle, comprising:
a framework including an L-shaped lower portion;
the L-shaped lower portion including a cradle portion and a pair of spaced-apart uprights integrally attached to the cradle portion;
a pair of wheels mounted to the L-shaped lower portion so that the framework is movable for placement adjacent the automotive vehicle;
a handle detachably securable to the L-shaped lower portion;
a pair of handle knobs mounted to the L-shaped lower portion for locking the handle to the L-shaped lower portion and for releasing the handle from the L-shaped lower portion;
a front housing bracket mounted to the cradle portion of the L-shaped lower portion and a rear housing bracket extending between and mounted to the uprights with the brackets positioned at the same height with respect to each other;
a housing for placement upon and securement to the brackets, the housing enclosing a host battery and a battery charger;
a pair of electrical cables electrically connected to the host battery and charger for charging the battery of the automotive vehicle; and
an electrical cord electrically connected to the host battery and the charger for plugging into a 110-AC volt electrical outlet so that the charger can be powered.

2. The portable battery charger of claim 1 wherein each upright includes an open upper end.

3. The portable battery charger of claim 2 wherein the handle includes opposed handle ends.

4. The portable battery charger of claim 3 further comprising a pair of sockets with each socket mounted to the upper end of each respective upright and each socket receiving therein one handle knob.

5. The portable battery charger of claim 4 further comprising a pair of battery cable holders projecting from the framework for supporting the electrical cables when the battery charger is not in use.

6. The portable battery charger of claim 5 further comprising a support plate mounted to and extending between the handles and against which the individual can brace his knees and legs when tilting and moving the battery charger.

7. A portable battery charger for charging the battery of an automotive vehicle, comprising:
a framework movable on the ground surface and including an L-shaped lower portion;
the L-shaped lower portion including a cradle portion and a pair of uprights integrally attached to the cradle portion;
a pair of wheels mounted to the L-shaped lower portion so that the framework can be positioned adjacent the automotive vehicle needing a battery jumpstart;
a u-shaped handle removably securable to the uprights of the L-shaped lower portion;
a pair of handle knobs with each handle knob mounted to each upright for locking the handle to the L-shaped lower portion by being tightened against the handle and for releasing the handle by backing the handle knobs away from the handle;
a front housing bracket mounted to the cradle portion of the L-shaped lower portion and a rear housing bracket mounted to and extending between the uprights with the brackets positioned at the same height to each other; and
a housing mounted on the front and rear housing brackets, the housing enclosing a host battery and an AC battery charger therein.

8. The portable battery charger of claim 7 further comprising a pair of battery cables electrically connected to the host battery and the battery charger for jumpstarting the dead battery of the automotive vehicle.

9. The portable battery charger of claim 8 further comprising an electrical cord electrically connected to the host battery and the AC battery charger for plugging into a 110-AC volt outlet so that the AC battery charger can be powered and charge maintained in the host battery.

10. The portable battery charger of claim 9 wherein each upright includes an open upper end.

11. The portable battery charger of claim 10 wherein the handle includes opposed handle ends so that the handle ends can be inserted into the upper ends of the uprights and secured therein by the handle knobs.

12. The portable battery charger of claim 11 further comprising a pair of battery cable holders mounted to the framework for supporting thereon the battery cables when the battery charger is not in use.

13. The portable battery charger of claim 12 further comprising a support plate extending between and mounted to the handle and against which the individual can brace his knees and legs when tilting and moving the battery charger.
